(19) United States
(12) Patent Application Publication
(10) Pub. No.: US 2012/0184646 A1
(43) Pub. Date: Jul. 19, 2012

(54) SEMICONDUCTOR-ENCAPSULATING LIQUID EPOXY RESIN COMPOSITION AND SEMICONDUCTOR DEVICE

(75) Inventors: Kazuaki SUMITA, Annaka-shi (JP); Yasuo KIMURA, Annaka-shi (JP); Tatsuya UEHARA, Annaka-shi (JP); Akira YAJIMA, Annaka-shi (JP)

(73) Assignee: Shin-Etsu Chemical Co., Ltd., Tokyo (JP)

(21) Appl. No.: 13/350,477

(22) Filed: Jan. 13, 2012

(30) Foreign Application Priority Data
Jan. 17, 2011 (JP) 2011-006737

(51) Int. Cl. C09D 163/00

(52) U.S. Cl. 523/440

(57) ABSTRACT

A semiconductor-encapsulating liquid epoxy resin composition comprises (A) a liquid epoxy resin, (B) an aromatic amine curing agent, and (C) an inorganic filler comprising an inorganic filler A which is a silica having an average particle size of 0.1 to 3 μm, and an inorganic filler B which is an amorphous nanosilica having an average particle size of 5 to 70 nm and having its surface treated with a coupling agent represented by the following formula (1) and/or (2):

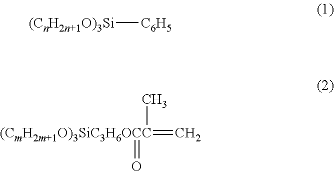

wherein n is an integer of 1 to 5, and m is 1 or 2.

### CROSS-REFERENCE TO RELATED APPLICATION

This non-provisional application claims priority under 35 U.S.C. §119(a) on Patent Application No. 2011-006737 filed in Japan on Jan. 17, 2011, the entire contents of which are hereby incorporated by reference.

### TECHNICAL FIELD

This invention relates to a semiconductor-encapsulating liquid epoxy resin composition which exhibits low viscosity and good penetration, and imparts excellent adhesion to the surface of a silicon chip and excellent toughness after curing; and which can be an encapsulant for a semiconductor device not causing failures even if reflow temperature raises by the use of a lead-free solder, not being deteriorated in the use under high temperature, high humidity conditions, and exhibiting no peeling and other failures in heat shock test. This invention also relates to a semiconductor device encapsulated with the cured product of the composition.

### BACKGROUND ART

With the demand of downsizing, weight reduction, and higher performance in electrical devices, dominant semiconductor mounting process has shifted from pin insertion to surface mounting. One type of such bare chip mounting is flip chip (FC) mounting wherein several to several ten thousand or more electrodes each having a height of about several μm to about 100 μm called “bumps” are formed on the wiring pattern surface of an LSI chip to thereby connect the bump to the electrode of the substrate. Accordingly, penetration of the encapsulant used for the encapsulation and protection of the flip chip into the gap between the substrate and the LSI chip is necessary.

The liquid epoxy resin composition which has been used for the flip chip underfill has been a blend of an epoxy resin, a curing agent, and an inorganic filler, and in this composition, a large amount of inorganic filler has been incorporated so that coefficient of linear expansion of the composition will be consistent with that of the chip, substrate, and bumps of the semiconductor, to thereby improve the reliability. Incorporation of such amount of the inorganic filler invites increase in the viscosity, and problems such as difficulty in the penetration of the composition into the gap between the substrate and the LSI chip, and hence, serious loss of productivity have been pointed out.

With the increase in the packing density of the semiconductor device, die size has increased and some dies have a size as large as 10 mm or more. In the case of the semiconductor device using such large size die, greater stress is applied to the die and the encapsulant during the solder ref lowing, and the problem of peeling at the interface between the encapsulant and the die or substrate as well as package cracks during the substrate mounting.

From the expectation that the use of leaded solders will be banned in the near future, a number of lead-substitute solders have been developed. Since most substitute solders have a melting temperature higher than that of the leaded solders, reflowing is likely to be conducted at a temperature of 260 to 270° C., and at such high reflow temperature, increase in the failures is expected as long as conventional liquid epoxy resin compositions are used for the encapsulation. Even if a flip chip type package which has so far raised no substantial problem were used, reflowing at such high temperature invites serious problems such as cracking in the reflowing and peeling at chip or substrate interface, and also, cracks in the resin, substrate, chip, or bumps after several hundred thermal cycles.

Typical prior art literatures of the present invention are as listed below.
JP-A H10-158366, JP-A H10-231351, JP-A 2000-327884, JP-A 2001-055486, JP-A 2001-055487, and JP-A 2001-055488.

### SUMMARY OF THE INVENTION

The present invention has been completed in view of such situation, and an object of the present invention is to provide a semiconductor-encapsulating liquid epoxy resin composition which exhibits low viscosity and good penetration, and imparts excellent adhesion to the silicon chip surface and, in particular, to a photosensitive polyimide resin and nitride film, and high toughness after curing. The cured product of the epoxy resin composition does not cause failure even if the use of a lead-free solder results in the raise of reflow temperature from the conventional temperature of around 240° C. to a temperature around 260 to 270° C., is not deteriorated under high temperature, high humidity conditions, for example, in the PCT (pressure cooker test at 121° C. and 2.1 atm), and exhibits no peeling or cracks after several hundred temperature cycles at 65° C. and 150° C.

Another object of the present invention is to provide a semiconductor device encapsulated by the cured product of the composition.

In order to realize the objects as described above, the inventors of the present invention made an intensive study, and found that a semiconductor-encapsulating liquid epoxy resin composition comprising
(A) a liquid epoxy resin,
(B) an aromatic amine curing agent in such an amount that a molar ratio of the entire amino group in the component (B) to the entire epoxy group in the component (A) is 0.7 to 1.2, and
(C) an inorganic filler comprising an inorganic filler A which is a silica having an average particle size of 0.1 to 3 μm, and an inorganic filler B which is an amorphous nanosilica having an average particle size of 5 to 70 nm and having its surface treated with a coupling agent having a particular structure,
the inorganic filler B being surface treated with 3 to 20 parts by weight of the coupling agent in relation to 100 parts by weight of the inorganic filler B, the content of the inorganic filler B being 0.2 to 10% by weight of the entire inorganic filler, and the content of the inorganic filler being 50 to 80% by weight of the entire composition comprising the components (A) to (C) exhibits a low viscosity and good penetration, and imparts excellent adhesion to the silicon chip surface and, in particular, to photosensitive polyimide resin and nitride film, and high toughness after curing. The cured product of the above epoxy resin composition does not cause failure even if the use of a lead-free solder results in the raise of reflow temperature from the conventional temperature of around 240° C. to a temperature around 260 to 270° C., is not deteriorated under high temperature, high humidity conditions, for example, in the PCT (pressure cooker test at 121° C. and 2.1 atm), and exhibits no peeling or cracks after several hundred temperature cycles at 65° C. and 150° C. The present invention has been completed based on such findings.

Accordingly, the present invention provides the following semiconductor-encapsulating liquid epoxy resin composition and the following semiconductor device.

[1] A semiconductor-encapsulating liquid epoxy resin composition comprising
(A) a liquid epoxy resin,
(B) an aromatic amine curing agent in such an amount that a molar ratio of the entire amino group in the component (B) to the entire epoxy group in the component (A) is 0.7 to 1.2, and
(C) an inorganic filler comprising an inorganic filler A which is a silica having an average particle size of 0.1 to 3 μm, and an inorganic filler B which is an amorphous nanosilica having an average particle size of 5 to 70 nm and having its surface treated with a coupling agent represented by the following formula (1) and/or (2):

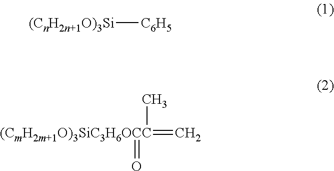

wherein n is an integer of 1 to 5, and m is 1 or 2,
the inorganic filler B being surface treated with 3 to 20 parts by weight of the coupling agent in relation to 100 parts by weight of the inorganic filler B, the content of the inorganic filler B being 0.2 to 10% by weight of the entire inorganic filler, and the content of the inorganic filler being 50 to 80% by weight of the entire composition comprising the components (A) to (C).
   [2] A semiconductor-encapsulating liquid epoxy resin composition according to [1] wherein the coupling agent is the one represented by the following formula (2′):

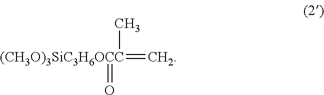

[3] A semiconductor-encapsulating liquid epoxy resin composition according to [1] or [2] wherein the component (B) is an aromatic amine curing agent represented by the following formula (3), (4), (5), or (6):

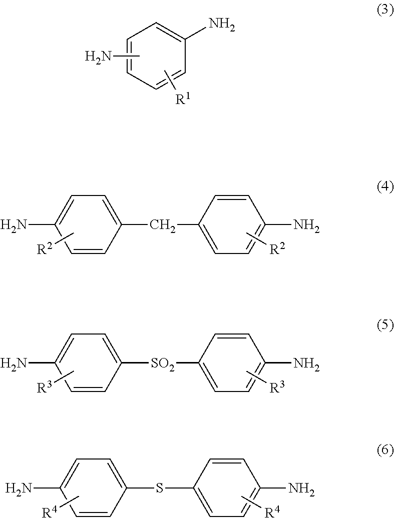

wherein R¹ to R⁴ are independently a group selected from among hydrogen atom, monovalent hydrocarbon groups containing 1 to 6 carbon atoms, CH₃S—, and C₂H₅S—.
[4] A semiconductor device encapsulated with the semiconductor-encapsulating liquid epoxy resin composition of any one of [1] to [3].

### ADVANTAGEOUS EFFECTS OF THE INVENTION

The present invention is capable of providing a semiconductor-encapsulating liquid epoxy resin composition which exhibits low viscosity and good penetration, and imparts excellent adhesion to the silicon chip surface and, in particular, to photosensitive polyimide resin and nitride film, and high toughness after curing. The cured product of the epoxy resin composition does not cause failure even if the use of a lead-free solder results in the raise of reflow temperature from the conventional temperature of around 240° C. to a temperature around 260 to 270° C., is not deteriorated under high temperature, high humidity conditions, for example, in the PCT (pressure cooker test at 121° C. and 2.1 atm), and exhibits no peeling or cracks after several hundred temperature cycles at 65° C. and 150° C. The present invention is also capable of providing semiconductor device encapsulated by the cured composition.

### DESCRIPTION OF THE EMBODIMENTS

### Liquid Epoxy Resin Composition

The semiconductor-encapsulating liquid epoxy resin composition of the present invention are constituted from the components (A) to (C), and the composition may also contain other optional components such as a low stress agent. In addition, a solvent may be used in the semiconductor-encapsulating liquid epoxy resin composition of the present invention.

Next, the components (A) to (C) and other optional components are described in detail.

### Component (A)

The liquid epoxy resin of the component (A) is not particularly limited as long as it is a liquid epoxy resin having up to 3 epoxy groups as its functional groups in one molecule, and being liquid at room temperature (20 to 30° C.), and any conventional liquid epoxy resin known in the art may be used. Examples include bisphenol epoxy resins such as bisphenol A epoxy resin, bisphenol F epoxy resin, and bisphenol AD epoxy resin, naphthalene epoxy resin, novolac epoxy resins such as phenol novolac epoxy resin and cresol novolac epoxy resin, biphenyl epoxy resins, glycidylamino epoxy resins, alicyclic epoxy resins, and dicyclopentadiene epoxy resins.

Among these, the preferred are bisphenol epoxy resins such as bisphenol A epoxy resin, bisphenol F epoxy resin, and bisphenol AD epoxy resin, naphthalene epoxy resin, and novolac epoxy resins such as phenol novolac epoxy resin and cresol novolac epoxy resin in view of the excellent heat resistance and moisture resistance. Among these, the most preferred are epoxy resins which is liquid at room temperature (20 to 30° C., and in particular 25° C.), and which has a viscosity of up to 200 Pa·s, especially up to 50 Pa·s when measured by a rotary viscometer.

The liquid epoxy resin may contain an epoxy resin represented by the following structural formula (7) or (8):

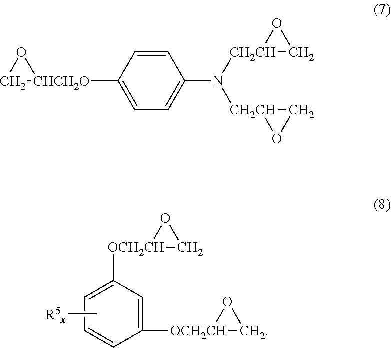

In the formula (8), R⁵ is hydrogen atom, or a monovalent hydrocarbon group containing 1 to 20, preferably 1 to 10, and more preferably 1 to 3 carbon atoms, and exemplary monovalent hydrocarbon groups include alkyl groups such as methyl group, ethyl group, propyl group, and isopropyl group, alkenyl groups such as vinyl group and allyl group; and x is an integer of 1 to 4, and in particular, 1 or 2.

When the epoxy resin represented by the formula (7) is incorporated, the amount incorporated is preferably at least 10% by weight, more preferably at least 25% by weight, and most preferably at least 50% by weight in the entire epoxy resin. Incorporation of the epoxy resin at an amount less than 10% by weight may result in the loss of heat resistance and increase in the viscosity. The upper limit may be 100% by weight.

Examples of the epoxy resin represented by the formula (7) include jER630LSD manufactured by Mitsubishi Chemical Corporation.

When the epoxy resin represented by the formula (8) is incorporated, the amount incorporated is preferably at least 25% by weight, more preferably at least 50% by weight, and most preferably at least 75% by weight in the entire epoxy resin. Incorporation of the epoxy resin at an amount less than 25% by weight may invite increase of the viscosity and loss of heat resistance of the cured composition. The upper limit may be 100% by weight.

Examples of the epoxy resin represented by the formula (8) include RE600NM manufactured by Nippon Kayaku Co., Ltd.

An epoxy resin contains a slight amount of chlorine from the epichlorohydrin used in the course of its synthesis. When chlorine is extracted from the epoxy resin with water at an epoxy resin concentration of 50% and a temperature of 100° C. for 20 hours, the water-extracted chlorine content is preferably up to 10 ppm. At a total chlorine content of more than 1,500 ppm or a water-extracted chlorine level of more than 10 ppm, the reliability of the sealed semiconductor device, particularly in the presence of moisture, may be compromised.

The epoxy resin as described above may be used alone or in combination of two or more.

### Component (B)

The aromatic amine curing agent of the component (B) is a curing agent for the component (A) as described above, and this aromatic amine curing agent is an aromatic ring-containing amine compound having excellent heat resistance and storage stability, which is preferably an aromatic amine curing agent represented by the following formula (3), (4), (5), or (6):

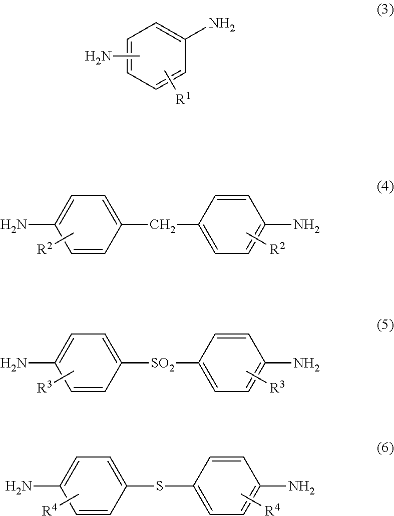

wherein R¹ to R⁴ are independently a group selected from hydrogen atom, a monovalent hydrocarbon group containing 1 to 6 carbon atoms, CH₃S—, and C₂H₅S—.

Of the aromatic amine curing agents represented by the formulae (3), (4), (5), and (6), the preferable curing agents include aromatic diaminodiphenylmethane compounds such as 3,3′-diethyl-4,4′-diaminophenylmethane, 3,3′,5,5′-tetramethyl-4,4′-diaminophenylmethane, and 3,3′,5,5′-tetraethyl-4,4′-diaminophenylmethane, 2,4-diaminotoluene, 1,4-diaminobenzene, and 1,3-diaminobenzene, which may be used alone or in combination of two or more.

Of the aromatic amine curing agents as described above, the curing agent which is liquid at room temperature (20 to 30° C.) can be added with no problem even if the curing agent is added with no further processing. However, the addition of a solid curing agent with no further processing invites increase in the viscosity of the resin composition, and serious loss of workability. Preferably, the solid curing agent is preliminarily mixed and melted with the liquid epoxy resin, and more specifically, at the particular mixing ratio as described below at a temperature in the range of 70 to 150° C. for 1 to 2 hours. When the temperature of mixing is less than 70° C., the aromatic amine curing agent may not be sufficiently compatibilized with the liquid epoxy resin, while mixing at a temperature in excess of 150° C. may invite reaction of the curing agent with the liquid epoxy resin, which may invite increase of the viscosity. When the period of mixing is less than 1 hour, the aromatic amine curing agent may not be fully compatibilized and this may invite increase in the viscosity. On the other hand, mixing for a period in excess of 2 hours may invite reaction of the curing agent with the liquid epoxy resin, and hence, increase in the viscosity.

The aromatic amine curing agent may be added at an amount such that a molar ratio of the entire amino group of the aromatic amine curing agent to the entire epoxy group of the component (A) is 0.7 to 1.2, preferably 0.7 to 1.1, and more preferably 0.85 to 1.05. When this molar ratio is less than 0.7, the epoxy group will partly be left unreacted, and this may invite decrease in the glass transition temperature or insufficient adhesion, while the molar ratio in excess of 1.2 may result in the brittleness of the cured product, and occurrence of cracks in the course of ref lowing or thermal cycling.

### Component (C)

The inorganic filler of the component (C) is an inorganic filler comprising an inorganic filler A which is a silica having an average particle size of 0.1 to 3 μm and an inorganic filler B which is an amorphous nanosilica having an average particle size of 5 to 70 nm. The inorganic filler B has its surface treated with a coupling agent represented by the formula (1) and/or (2) as described below with 3 to 20 parts by weight of the coupling agent in relation to 100 parts by weight of the inorganic filler B. The content of the inorganic filler B is 0.2 to 10% by weight of the entire inorganic filler, and the content of the inorganic filler is 50 to 80% by weight of the entire composition comprising the components (A) to (C).

The inorganic fillers A and B are spherical silicas, and their average particle size may be measured by using centrifugal sedimentation, laser diffractometry, or dynamic light scattering known in the art. The inorganic filler A is preferably measured by laser diffractometry which is convenient and capable of measuring a wide range of particle diameter, and the inorganic filler B is preferably measured by dynamic light scattering capable of conducting a high precision submicron measurement.

The inorganic filler A should be controlled to an average particle size of 0.1 to 3 μm, and preferably 0.3 to 2 μm. When the average particle size is in excess of 3 μm, penetration cross section may be reduced to adversely affect the penetration ability, and filler precipitation in the penetration and curing may result in the slope of thermal coefficient of expansion between the chip side and the substrate side and this may invite loss of reliability against the thermal shock. On the other hand, average particle size of less than 1 μm results in an increased viscosity.

The inorganic filler A used may be the one preliminarily surface treated with a coupling agent such as a silane coupling agent or a titanate coupling agent in order to increase binding strength of the resin with the inorganic filler. Exemplary preferable coupling agents include silane coupling agents such as epoxysilanes such as γ-glycidoxypropyltrimethoxysilane, γ-glycidoxypropylmethyldiethoxysilane, and β-(3,4-epoxycyclohexyl)ethyltrimethoxysilane, amino silanes such as N-β(aminoethyl)-γ-aminopropyltrimethoxysilane, γ-aminopropyltriethoxysilane, and N-phenyl-γ-aminopropyltrimethoxysilane,

mercapto silanes such as γ-mercaptopropyltrimethoxysilane.

The amount and the surface treating method of the coupling agent used for the surface treatment are not particularly limited, and the surface treatment may be accomplished by using a method known in the art.

The inorganic filler B is amorphous nanosilica particle, and the average particle size should be controlled to the range of 5 to 50 nm, and preferably 10 to 50 nm. Thin film penetration ability can be further improved by treating surface of the inorganic filler B having such average particle size with the coupling agent as described below, and incorporating the inorganic filler B at a particular content with the inorganic filler A.

Such amorphous nanosilica particles may be synthesized, as described, for example, in JP-B 1-55201 by forming chemical flame by a burner in an atmosphere containing oxygen, and introducing metal silicon in the chemical flame to form dust cloud, and to thereby induce explosion.

The silane coupling agent used for the surface treatment of the amorphous nanosilica may be those represented by the following formula (1) or (2):

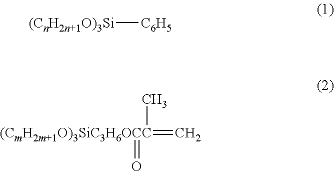

wherein n is an integer of 1 to 5, and m is 1 or 2, and preferably, the one represented by the following formula (2′):

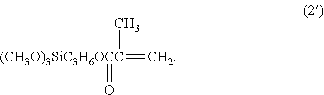

Examples of the coupling agent represented by formula (1) or (2) include KBM103, KBM503, and KBE503 manufactured by Shin-Etsu Chemical Co., Ltd.

When the amorphous nanosilica particle is surface treated with a typical coupling agent other than those represented by the formulae (1) and (2), for example, with a silane coupling agent such as an epoxy silane such as γ-glycidoxypropyltrimethoxysilane, γ-glycidoxypropylmethyldiethoxysilane, or β-(3,4-epoxycyclohexyl)ethyltrimethoxysilane, an amino silanes such as N-β(aminoethyl)-γ-aminopropyltrimethoxysilane, γ-aminopropyltriethoxysilane, or N-phenyl-γ-aminopropyltrimethoxysilane,

a mercapto silane such as γ-mercaptopropyltrimethoxysilane, the amorphous nanosilica particles may be aggregated, and may not be able to be dispersed in the liquid epoxy resin composition.

When the inorganic filler B is surface treated with the coupling agent represented by the formula (1) or (2), 3 to 20 parts by weight, and more preferably 5 to 15 parts by weight may be used in relation to 100 parts by weight of the inorganic filler B. The surface treatment of the inorganic filler B with less than 3 parts by weight of the coupling agent results in the loss of strength, whereas the surface treatment with more than 20 parts by weight of the coupling agent also results in the loss of the strength.

The amount of the coupling agent used for the surface treatment and the method used in such treatment are not particularly limited, and the surface treatment may be conducted by a method known in the art.

The content of the inorganic filler B in the entire inorganic filler should be controlled to the range of 0.2 to 10% by weight, and more preferably to the range of 0.5 to 5% by weight, and control of the content to such range realizes decrease in the viscosity of the liquid epoxy resin composition as well as good penetration to the narrow gap presumably because, while the effect of fine powder to the matrix in the composition with high content of the organic resin is hidden by the flowability of the organic resin, flowability of the organic resin between the inorganic filler changes depending on the amount of the nano size inorganic filler B and this change in the flowability has various effects.

The content of such inorganic filler (component (C)) is preferably 50 to 80% by weight and more preferably 60 to 75% by weight of the entire composition comprising the components (A) to (C). The content of less than 50% by weight results in the high coefficient of expansion, and cracks are induced in the thermal shock test, and the content in excess of 80% by weight results in high viscosity and loss of thin film penetration ability.

The preferred semiconductor device to be encapsulated with the epoxy resin composition of the invention is preferably a semiconductor device having a gap size in the range of about 10 μm to about 200 μm, more preferably a flip chip type semiconductor device, and most preferably a flip chip type semiconductor device having a die size in excess of 10 mm. In this case, the use of an inorganic filler having an average particle size of up to about one-tenth and a maximum particle size of up to one-half of the flip chip gap (between the substrate and semiconductor chip) is preferable for realizing both improved penetration ability and lower linear expansion.

### Other Components

If desired, the semiconductor-encapsulating liquid epoxy resin composition of the present invention may also contain various additives. For example, the composition may also include a thermoplastic resin, a thermoplastic elastomer, an organic synthetic rubber, a low stress agent such as silicone low stress agent (for example, a block copolymer of an epoxy resin such as novolac epoxy resin with an organopolysiloxane), a wax such as carnauba wax, higher fatty acid, and synthetic wax, a colorant such as carbon black, halogen trapping agent and a solvent.

Exemplary solvents include methyl ethyl ketone and carbitol acetate.

### [Production Method of the Composition]

The semiconductor-encapsulating liquid epoxy resin composition may be produced by simultaneously or separately agitating, dissolving, mixing, or dispersing the components (A) to (C) and other optional components with optional heating. The apparatus used for the mixing, agitation, and dispersion, is not particularly limited, and examples of the apparatus include an automated mortar, three-roll mill, ball mill, planetary mixer, and bead mill having agitating and heating units incorporated therein, which may be used alone or in combination of two or more.

### [Curing Method of the Composition]

The semiconductor-encapsulating liquid epoxy resin composition may be cured by a method known in the art, and preferably, by first curing in an oven at 100 to 120° C. for at least 0.5 hour, and in particular, for 0.5 to 2 hours, and then curing in an oven at 130 to 250° C. for at least 0.5 hour, and in particular, for 0.5 to 5 hours. When the heating at 100° C. to 120° C. is conducted for a period less than 0.5 hour, void may be left after the curing, while the cured article may not have sufficient properties when the heating at 130° C. to 250° C. is conducted for a period less than 0.5 hour.

### EXAMPLES

Next, the present invention is described in further detail by referring to the Examples and Comparative Examples, which by no means limit the scope of the present invention.

### Examples 1 to 8 and Comparative Examples 1 to 5

Liquid epoxy resin, curing agent, inorganic filler, and other components were blended as shown in Tables 2 and 3, and the mixture was homogeneously kneaded by three rolls to obtain various epoxy resin compositions.

### [Materials Used]

### (A) Liquid Epoxy Resin

Bisphenol F epoxy resin:
   YDF8170 (manufactured by Tohto Kasei Co., Ltd.)
Epoxy resin represented by the following formula (7):
   jER630LSD (manufactured by Mitsubishi Chemical Corporation)

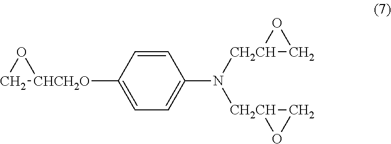

### (B) Amine Curing Agent

4,4′-diamino-3,3′-diethyldiphenylmethane (manufactured by Nippon Kayaku Co., Ltd.)

### (C) Inorganic Filler

Spherical silica particles were surface treated as shown in Table 1 to produce various inorganic fillers.

Amount of the coupling agent shown in Table 1 is the amount in relation to 100 parts by weight of the spherical silica particles.

TABLE 1

| | | |
|---|---|---|
| Inorganic | a | Average particle size, 2 μm; |
| filler A | | surface treated with KBM403 (1 part by weight) |
| | b | Average particle size, 0.8 μm; |
| | | surface treated with KBM573 (1 part by weight) |
| | c | Average particle size, 0.3 μm; |
| | | surface treated with KBM573 (2 parts by weight) |
| Inorganic | a | Average particle size, 50 nm; |
| filler B | | surface treated with KBM103 (5 parts by weight) |
| | b | Average particle size, 10 nm; |
| | | surface treated with KBM103 (8 parts by weight) |
| | c | Average particle size, 50 nm; |
| | | surface treated with KBM503 (5 parts by weight) |
| | d | Average particle size, 10 nm; |
| | | surface treated with KBM503 (8 parts by weight) |
| | e | Average particle size, 50 nm; |
| | | surface treated with KBM573 (5 parts by weight) |
| | f | Average particle size, 10 nm; |
| | | surface treated with KBM573 (8 parts by weight) |
| | g | Average particle size, 110 nm; |
| | | surface treated with KBM103 (5 parts by weight) |

Coupling agent: KBM403, 3-glycidoxypropyltrimethoxysilane (manufactured by Shin-Etsu Chemical Co., Ltd.)
Coupling agent: KBM573, N-phenyl-3-aminopropyltrimethoxy-silane (manufactured by Shin-Etsu Chemical Co., Ltd.)
Coupling agent: KBM103, phenyltrimethoxysilane (manufactured by Shin-Etsu Chemical Co., Ltd.)
Coupling agent: KBM503, 3-methacryloxypropyltrimethoxy-silane (manufactured by Shin-Etsu Chemical Co., Ltd.)

### (D) Other Components

Coupling agent: KBM403, 3-glycidoxypropyl trimethoxysilane (manufactured by Shin-Etsu Chemical Co., Ltd.)
Carbon black: Denka Black (manufactured by Denki Kagaku Kogyo Kabushiki Kaisha)
Catalyst: DBU (manufactured by San-Apro Ltd.)
Solvent: EDGAC (manufactured by Daicel Corporation

### [Evaluation Method]

### (1) Viscosity

Viscosity at 25° C. was measured by BH type rotary viscometer at a rotation rate of 4 rpm.

### (2) Tg (Glass Transition Temperature), CTE1 (Coefficient of Expansion), and CTE2 (Coefficient of Expansion)

The composition was cured at 120° C. for 0.5 hour and 165° C. for 3 hours to prepare a test piece of the cured product (5 mm×5 mm×15 mm). By using the thus prepared test piece, and raising the temperature at 5° C. per minute, Tg was measured by TMA (thermomechanical analysis apparatus). Coefficient of expansion was also measured for a temperature range of 50 to 80° C. (CTE1) and 200 to 230° C. (CTE2).

### (3) Fracture Toughness K_{1c}

The composition was cured at 120° C. for 0.5 hour and at 165° C. for 3 hours. The resulting cured product was measured for fracture toughness K1c at room temperature according to ASTM #D5045.

### (4) Bond Strength Test

A frustconical polytetrafluoroethylene mold having a top diameter of 2 mm, a bottom diameter of 5 mm, and a height of 3 mm was filled with the resin composition, and a silicon chip or a copper plate coated with a polyimide (PI) coating was placed on the thus filled resin composition. After curing the resin at 150° C. for 3 hours, the polytetrafluoroethylene mold was removed, and the resulting test piece was pushed at a constant speed (1 mm/second) to measure shear bond strength. This value was the initial value. Next, the cured test piece was placed in a pressure cooker tester (121° C./2.1 atm), and after leaving in the pressure cooker tester for 72 hours, the bond strength was measured in similar manner. In each case, 5 test pieces were measured, and the average is indicated as the adhesion force. In Table 2, “0” means peeling.

### (5) Void Test

A flip chip semiconductor package having a 10 mm×10 mm polyimide (PI)-coated silicon chip placed on a 30 mm×30 mm FR-4 substrate at a gap of about 50 μm, and the resin composition was introduced dropwise into this gap. After curing the resin at 150° C. for 3 hours, presence of the void was checked by C-SAM (manufactured by SONIX).

(6) Thermal shock test

The test semiconductor package prepared by the procedure as described above was held at 30° C. and relative humidity of 65% for 192 hours, and then processed 5 times by IR reflow set at a maximum temperature of 265° C. The package was then tested by thermal cycling between −65° C. for 30 minutes and 150° C. for 30 minutes. After 250, 500, 750, and 1000 cycles, the package was examined by the procedure as described above to find percentage (%) of the chip with the cracks.

TABLE 2

| Formulation | | Example | | | | | | | |
|---|---|---|---|---|---|---|---|---|---|
| (pats by weight) | | 1 | 2 | 3 | 4 | 5 | 6 | 7 | 8 |
| Epoxy resin | YDF8170 | 33 | 33 | 33 | 33 | 33 | 33 | 33 | 33 |
| | jER630LSD | 33 | 33 | 33 | 33 | 33 | 33 | 33 | 33 |
| Curing agent | Kayahard AA | 34 | 34 | 34 | 34 | 34 | 34 | 34 | 34 |
| Inorganic | a | 237.6 | 237.6 | 237.6 | 237.6 | | | | |
| filler A | b | | | | | 198 | 198 | 198 | 198 |
| | c | | | | | | | | |
| Inorganic | a | 2.4 | | | | 2.0 | | | |
| filler B | b | | 2.4 | | | | 2.0 | | |
| | c | | | 2.4 | | | | 2.0 | |
| | d | | | | 2.4 | | | | 2.0 |
| | e | | | | | | | | |
| | f | | | | | | | | |
| | g | | | | | | | | |
| Other | KBM403 | 1.0 | 1.0 | 1.0 | 1.0 | 1.0 | 1.0 | 1.0 | 1.0 |
| components | DBU | 0.3 | 0.3 | 0.3 | 0.3 | 0.3 | 0.3 | 0.3 | 0.3 |
| | EDGAC | 2.0 | 2.0 | 2.0 | 2.0 | 2.0 | 2.0 | 2.0 | 2.0 |
| Parameter | Amino/Epoxy ratio | 1.00 | 1.00 | 1.00 | 1.00 | 1.00 | 1.00 | 1.00 | 1.00 |
| of the | (molar ratio) | | | | | | | | |
| composition | Content of inorganic | 70 | 70 | 70 | 70 | 66 | 66 | 66 | 66 |
| | filler (%) | | | | | | | | |
| Evaluation | Viscosity | 63 | 57 | 66 | 63 | 28 | 25 | 26 | 25 |
| of the | (Pa · s/25° C.) | | | | | | | | |
| composition | Tg (° C.) | 115 | 116 | 113 | 115 | 115 | 117 | 115 | 115 |
| | CTE1 (ppm/° C.) | 23 | 23 | 23 | 23 | 27 | 27 | 27 | 27 |
| | CTE2 (ppm/° C.) | 83 | 83 | 83 | 83 | 95 | 95 | 95 | 95 |
| | K_{1c} (MPam^{1/2}) | 2.4 | 2.4 | 2.4 | 2.4 | 2.4 | 2.4 | 2.4 | 2.4 |
| Evaluation | Initial | 11.6 | 12.3 | 13.5 | 15.6 | 19.5 | 15.6 | 16.9 | 18.4 |
| of PI Adhesion | After 72 hours | 4.3 | 4.6 | 3.1 | 5.6 | 13.1 | 12.5 | 12.1 | 12 |
| (MPa) | of PCT | | | | | | | | |
| Void test | | None | None | None | None | None | None | None | None |
| Percent | 250 | 0 | 0 | 0 | 0 | 0 | 0 | 0 | 0 |
| defective (%) | 500 | 0 | 0 | 0 | 0 | 0 | 0 | 0 | 0 |
| in the thermal | 750 | 0 | 0 | 0 | 0 | 0 | 0 | 0 | 0 |
| shock test | 1,000 | 0 | 0 | 0 | 0 | 0 | 0 | 0 | 0 |
| | 1,250 | 0 | 0 | 0 | 0 | 0 | 0 | 0 | 0 |

TABLE 3

| Formulation | | Comparative Example | | | | |
|---|---|---|---|---|---|---|
| (pats by weight) | | 1 | 2 | 3 | 4 | 5 |
| Epoxy resin | YDF8170 | 33 | 33 | 33 | 33 | 33 |
| | jER630LSD | 33 | 33 | 33 | 33 | 33 |
| Curing agent | Kayahard AA | 34 | 34 | 34 | 34 | 34 |
| Inorganic | a | 69.3 | 237.6 | 237.6 | 237.6 | 213.6 |
| filler A | b | | | | | |
| | c | | | | | |
| Inorganic | a | 0.7 | | | | 26.4 |
| filler B | b | | | | | |
| | c | | | | | |
| | d | | | | | |
| | e | | 2.4 | | | |
| | f | | | 2.4 | | |
| | g | | | | 2.4 | |
| Other | KBM403 | 1 | 1 | 1 | 1 | 1 |
| components | DBU | 0.3 | 0.3 | 0.3 | 0.3 | 0.3 |
| | EDGAC | 2 | 2 | 2 | 2 | 2 |
| Parameter | Amino/Epoxy ratio | 1.00 | 1.00 | 1.00 | 1.00 | 1.00 |
| of the | (molar ratio) | | | | | |
| composition | Content of inorganic | 40 | 70 | 70 | 70 | 70 |
| | filler (%) | | | | | |
| Evaluation | Viscosity | 21 | 89 | 99 | 145 | Paste |
| of the | (Pa · s/25° C.) | | | | | |
| composition | Tg (° C.) | 115 | 115 | 115 | 115 | — |
| | CTE1 (ppm/° C.) | | 24 | 24 | 24 | — |
| | CTE2 (ppm/° C.) | | 82 | 82 | 82 | — |
| | K_{1c} (MPam^{1/2}) | 2.1 | 2.1 | 2.1 | 1.9 | — |
| Evaluation | Initial | 10.3 | 8.6 | 8.3 | 7.5 | 8.9 |
| of PI Adhesion | After 72 hours | 4.3 | 2.2 | 1.6 | 0.8 | 0 |
| (MPa) | of PCT | | | | | |
| Void test | | NG | NG | NG | NG | No |
| | | | | | | penetration |
| Percent | 250 | 0 | 0 | 0 | — | — |
| defective (%) | 500 | 30 | 0 | 0 | — | — |
| in the thermal | 750 | 100 | 0 | 0 | — | — |
| shock test | 1,000 | | 5 | 10 | — | — |
| | 1,250 | | 30 | 40 | — | — |

### INDUSTRIAL APPLICABILITY

This invention provides to a semiconductor-encapsulating liquid epoxy resin composition which exhibits low viscosity and good penetration, and imparts excellent adhesion to the surface of a silicon chip, and in particular, to photosensitive polyimide resin and nitride film, and excellent toughness after curing; and which can be an encapsulant for a semiconductor device not causing failure even if reflow temperature raises by the use of a lead-free solder, not being deteriorated in the use under high temperature, high humidity conditions, and exhibiting no peeling and other failures in heat shock test. This invention also provides a semiconductor device encapsulated by the cured composition. Accordingly, the present invention has high industrial utility.

Japanese Patent Application No. 2011-006737 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A semiconductor-encapsulating liquid epoxy resin composition comprising
(A) a liquid epoxy resin,
(B) an aromatic amine curing agent in such an amount that a molar ratio of the entire amino group in the component (B) to the entire epoxy group in the component (A) is 0.7 to 1.2, and
(C) an inorganic filler comprising an inorganic filler A which is a silica having an average particle size of 0.1 to 3 μm, and an inorganic filler B which is an amorphous nanosilica having an average particle size of 5 to 70 nm and having its surface treated with a coupling agent represented by the following formula (1) and/or (2): 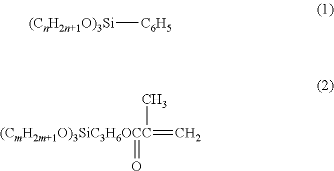
wherein n is an integer of 1 to 5, and m is 1 or 2,
the inorganic filler B being surface treated with 3 to parts by weight of the coupling agent in relation to 100 parts by weight of the inorganic filler B, the content of the inorganic filler B being 0.2 to 10% by weight of the entire inorganic filler, and the content of the inorganic filler being 50 to 80% by weight of the entire composition comprising the components (A) to (C).

2. A semiconductor-encapsulating liquid epoxy resin composition according to claim 1 wherein the coupling agent is the one represented by the following formula (2′):

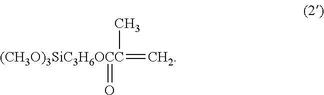

3. A semiconductor-encapsulating liquid epoxy resin composition according to claim 1 wherein the component (B) is an aromatic amine curing agent represented by the following formula (3), (4), (5), or (6): 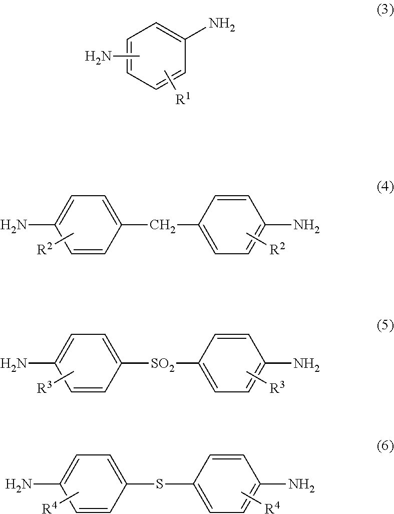
wherein R¹ to R⁴ are independently a group selected from among hydrogen atom, monovalent hydrocarbon groups containing 1 to 6 carbon atoms, CH₃S—, and C₂H₅S—.

4. A semiconductor device encapsulated with the semiconductor-encapsulating liquid epoxy resin composition of claim 1.
